(19) United States
(12) Patent Application Publication
(10) Pub. No.: US 2013/0314028 A1
(43) Pub. Date: Nov. 28, 2013

(54) WIRELESS CHARGING SYSTEM

(71) Applicant: HON HAI PRECISION INDUSTRY CO., LTD., New Taipai (TW)

(72) Inventor: KUO-FONG TSENG, New Taipei (TW)

(73) Assignee: HON HAI PRECISION INDUSTRY CO., LTD., New Taipei (TW)

(21) Appl. No.: 13/674,196

(22) Filed: Nov. 12, 2012

(30) Foreign Application Priority Data
May 25, 2012 (TW) 101118786

(51) Int. Cl. H02J 7/00

(52) U.S. Cl. CPC H02J 7/0042
USPC 320/107

(57) ABSTRACT

A wireless charging system includes a power supply device transmitting electrical energy, a terminal device for charging, a laser charging transmitting module, and a laser charging receiving module. The laser charging transmitting module is electrically connected with the power supply device for receiving electrical energy transmitted by the power supply device and transforming electrical energy into light energy. The laser charging receiving module is electrically connected with the terminal device for charging, for receiving light energy transformed by the laser charging transmitting module, transforming light energy into electrical energy, and transmitting electrical energy to the terminal device for charging to charge up the terminal device for charging.

### BACKGROUND

1. Technical Field

The present disclosure relates to a wireless charging system, and particularly to a wireless charging system used for a portable electronic device.

2. Description of the Related Art

Typically, batteries provide the electrical power required by the portable electronic devices such as mobile phones, tablet computers, and notebook computers. When the batteries are discharged, a fixed or directly wired power source and an electrical charger are needed to charge the batteries. Thus, it is inconvenient to charge the batteries of the portable electronic devices dependent on the directly wired power source and the electrical charger.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a layout for one embodiment of a wireless charging system placed in a room.

FIG. 2 is a diagram of the wireless charging system in FIG. 1.

### DETAILED DESCRIPTION

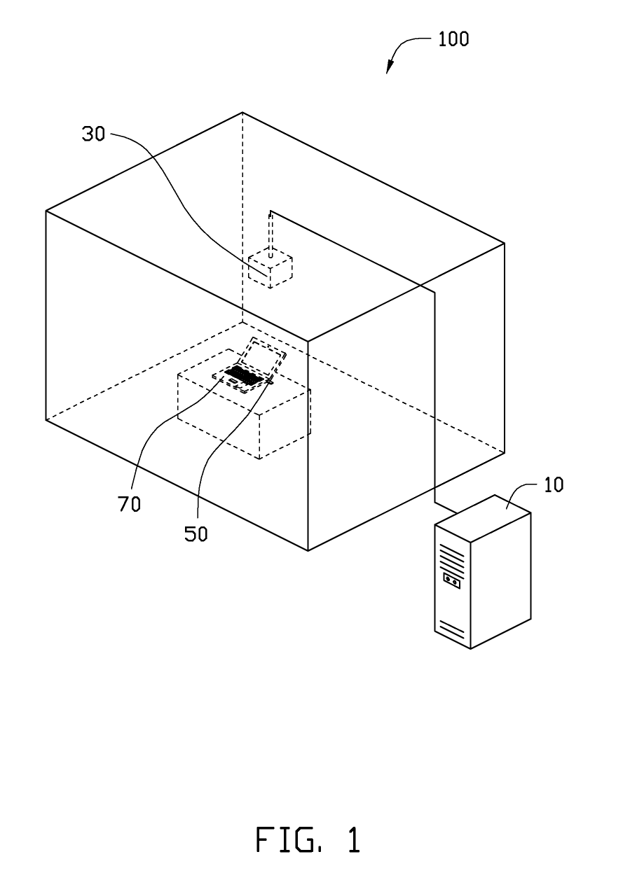

FIG. 1 shows a layout for one embodiment of a wireless charging system 100 placed in a room. The wireless charging system 100 includes a power supply device 10, a laser charging transmitting module 30, a laser charging receiving module 50, and a terminal device for charging 70. The laser charging transmitting module 30 is electrically connected with the power supply device 10 via an electrical cable, for receiving electrical energy transmitted by the power supply device 10 and transforming the electrical energy into light energy. The laser charging receiving module 50 is electrically connected with the terminal device for charging 70, for receiving the light energy transformed by the laser charging transmitting module 30, transforming the light energy into electrical energy, and transmitting the electrical energy to the terminal device for charging 70, such that the terminal device for charging 70 is thereby charged. In an illustrated embodiment, the power supply device 10 is a power supply room.

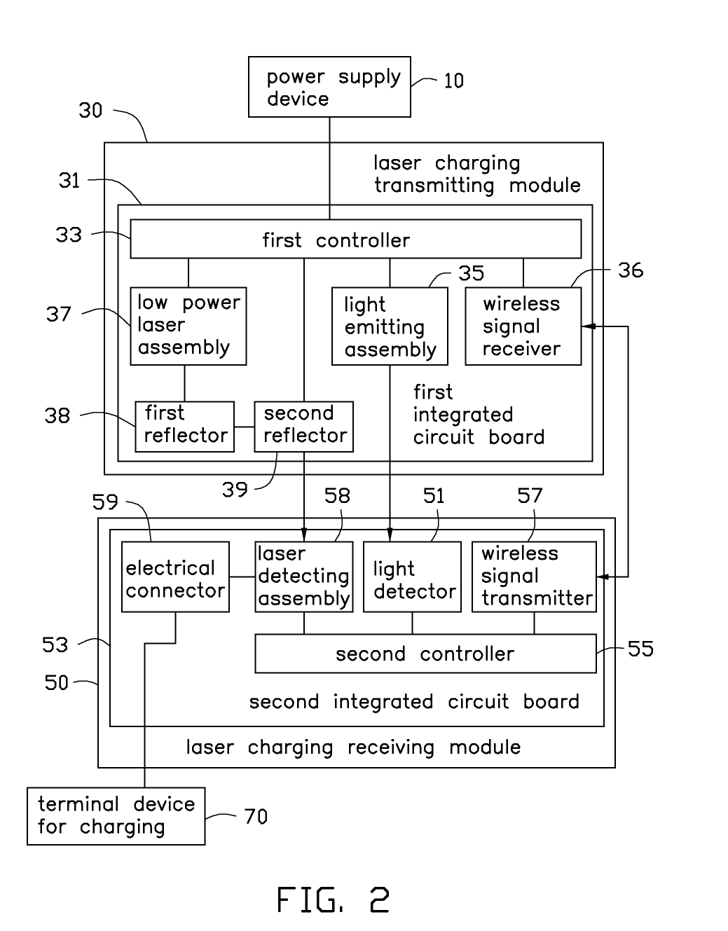

Referring also to FIG. 2, the laser charging transmitting module 30 includes a first integrated circuit board 31, a first controller 33, a light emitting assembly 35, a wireless signal receiver 36, a low power laser assembly 37, a first reflector 38, and a second reflector 39. The first integrated circuit board 31 is electrically connected with the power supply device 10. The light emitting assembly 35 and the wireless signal receiver 36 are electrically connected with the first integrated circuit board 31. The first controller 33 is placed on and electrically connected with the first integrated circuit board 31, for controlling the wireless signal receiver 36, the low power laser assembly 37, and the second reflector 39. The light emitting assembly 35 is placed on and electrically connected with the first integrated circuit board 31, for receiving the electrical energy transmitted by the power supply device 10, transforming the electrical energy into light energy, and then transmitting the light energy to the room. The light emitting assembly 35 is a light emitting diodes lamp. In other embodiments, the light emitting assembly 35 can be selected from other types of light emitting devices, for example, a laser lamp. The wireless signal receiver 36 is placed on and electrically connected with the first integrated circuit board 31, for receiving a position signal transmitted by the laser charging receiving module 50 and transmitting the position signal to the first controller 33. The low power laser assembly 37 is placed on and electrically connected with the first integrated circuit board 31, for emitting laser beams to the laser charging receiving module 50. The first reflector 38 is securely mounted on the first integrated circuit board 31 opposite to the low power laser assembly 37. The second reflector 39 is movably mounted on the first integrated circuit board 31, and is electrically connected with the first controller 33. The second reflector 39 is configured to be corresponding to the first reflector 38, for reflecting the laser beams.

In the illustrated embodiment, the laser charging transmitting module 30 has function capabilities including emitting light and transforming electrical energy into light energy. The laser charging transmitting module 30 is placed on a higher vertical position relative to a floor of the room, such as a roof or a position on a wall surface away from the floor. In other embodiments, the laser charging transmitting module 30 can be obtained by reconstructing or reconfiguring a conventional light emitting device, for example, a light emitting diodes lamp, together with other components. The light emitting diodes lamp constructed with the first controller 33 belongs to the laser charging transmitting module 30.

The laser charging receiving module 50 can be a portable USB flash disk. In use, the laser charging receiving module 50 is electrically connected with the terminal device for charging 70 in a plug-and-play manner, for receiving the laser beams emitted by the laser charging transmitting module 30, transforming the laser beams into electrical energy, and transmitting the electrical energy to the terminal device for charging 70, such that the terminal device for charging 70 is charged.

The laser charging receiving module 50 includes a light detector 51, a second integrated circuit board 53, a second controller 55, a wireless signal transmitter 57, a laser detecting assembly 58, and an electrical connector 59. The light detector 51 is electrically connected with the second integrated circuit board 53, for receiving the light energy emitted by the light emitting assembly 35 of the laser charging transmitting module 30, transforming the light energy into electrical energy, and then transmitting the electrical energy to the second controller 55, the wireless signal transmitter 57, and the laser detecting assembly 58. The second controller 55 is placed on the second integrated circuit board 53, and is electrically connected with the second integrated circuit board 53 and the light detector 51, such that the second controller 55 is started or acutated by the electrical energy provided from the light detector 51, for controlling the wireless signal transmitter 57 and the laser detecting assembly 58. The wireless signal transmitter 57 is placed on the second integrated circuit board 53, and is electrically connected with the second integrated circuit board 53, the light detector 51, and the second controller 55, for transmitting the position signal. The laser detecting assembly 58 is placed on the second integrated circuit board 53, and is electrically connected with the second integrated circuit board 53, the light detector 51, and the second controller 55, for transforming a light energy transmitted by the low power laser assembly 37 into an electrical energy. The electrical connector 59 is placed on the second integrated circuit board 53, and is electrically connected with the second integrated circuit board 53 and the laser detecting assembly 58, for transmitting the electrical energy transformed by the laser charging receiving module 50 to the terminal device for charging 70, such that the terminal device for charging 70 is being charged.

In the illustrated embodiment, the terminal device for charging 70 is a portable electronic device, such as a notebook computer or a mobile phone. The electrical connector can be a USB connector or other electrical connector.

In use, an electrical energy supplied by the power supply device 10 is transmitted to the laser charging transmitting module 30, to start the first controller 33, the light emitting assembly 35, the wireless signal receiver 36, and the low power laser assembly 37. Light energy is transmitted to the room by the light emitting assembly 35 and thereby lighting the room. The laser charging receiving module 50 receives light energy emitted by the light emitting assembly 35 via the light detector 51, transforms the light energy into electrical energy, and then transmits the electrical energy to the second controller 55, the wireless signal transmitter 57, and the laser detecting assembly 58. The wireless signal transmitter 57 controlled by the second controller 55 transmits the position signal, and then the wireless signal receiver 36 of the laser charging transmitting module 30 receives the position signal and transmits the position signal to the first controller 33. The first controller 33 confirms a position of the laser charging receiving module 50 via the position signal, and then an angle expressed in degrees formed between the second reflector 39 and the laser detecting assembly 58 is adjusted to reflect the laser beams transmitted by the low power laser assembly 37 to the laser detecting assembly 58. The low power laser assembly 37 transmits the light beams controlled by the first controller 33, and then the light beams are reflected by the first reflector 38 and the second reflector 39 to the laser detecting assembly 58. The laser beams are transformed into electrical energy by the laser detecting assembly 58, and are transmitted to the terminal device for charging 70 via the electrical connector 59, to charge up the terminal device for charging 70.

The power supply device 10 and the laser charging transmitting module 30 can be used as a fixed or stationary power source, and the laser charging receiving module 50 can be used as a charging connector, such that the terminal device for charging 70 can be charged without physically connecting with the charging connector. Thus, it is convenient to charge electrical power to the portable electronic device.

It is to be understood, however, that even through numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A wireless charging system comprising:
a power supply device transmitting an electrical energy;
a terminal device for charging;
a laser charging transmitting module electrically connected with the power supply device for receiving the electrical energy transmitted by the power supply device and transforming the electrical energy into a light energy; and
a laser charging receiving module electrically connected with the terminal device for charging, for receiving the light energy transformed by the laser charging transmitting module, transforming the light energy into an electrical energy, and transmitting the electrical energy to the terminal device for charging to perform charging.

2. The wireless charging system of claim 1, wherein the laser charging transmitting module comprises a first integrated circuit board, a first controller, a light emitting assembly, and a low power laser assembly; the first controller is electrically connected with the first integrated circuit board and the low power laser assembly for controlling the low power laser assembly; the low power laser assembly is capable of emitting a laser beam to the laser charging receiving module controlled by the first controller, and the light emitting assembly is electrically connected with the first integrated circuit board, for transforming the electrical energy into light energy.

3. The wireless charging system of claim 2, wherein the first controller and the light emitting assembly are placed on the first integrated circuit board.

4. The wireless charging system of claim 2, wherein the laser charging receiving module comprises a light detector, a second integrated circuit board, a second controller, and a laser detecting assembly; the light detector is electrically connected with the second integrated circuit board, for receiving the light energy transmitted by the laser charging transmitting module, transforming the light energy into the electrical energy, and then transmitting the electrical energy to the second controller and the laser detecting assembly, the second controller is electrically connected with the second integrated circuit board, for controlling the laser detecting assembly, and the laser detecting assembly is electrically connected with the second integrated circuit board and the second controller, for receiving the light beam emitted by the low power laser assembly, transforming the light beam into an electrical energy and transmitting the electrical energy to the terminal device for charging.

5. The wireless charging system of claim 4, wherein the laser charging receiving module further comprise a wireless signal transmitter, the wireless signal transmitter is electrically connected with the second integrated circuit board, the light detector, and the second controller, for transmitting a position signal.

6. The wireless charging system of claim 5, wherein the wireless signal transmitter is placed on the second integrated circuit board.

7. The wireless charging system of claim 5, wherein the laser charging transmitting module further comprises a wireless signal receiver, the wireless signal receiver is electrically connected with the first integrated circuit board, for receiving the position signal transmitted by the wireless signal transmitter and transmitting the position signal to the first controller to confirm the position of the laser charging receiving module.

8. The wireless charging system of claim 4, wherein the laser charging receiving module further comprises an electrical connector electrically connected with the second integrated circuit board and the laser detecting assembly, in use, the electrical connector is plugged in the terminal device for charging to be electrically connected therewith, such that the electrical energy transformed by the laser detecting assembly is transmitted to the terminal device for charging via the electrical connector.

9. The wireless charging system of claim 8, wherein the electrical connector is placed on the second integrated circuit board.

10. The wireless charging system of claim 2, wherein the laser charging transmitting module further comprises a first reflector and a second reflector, the first reflector is securely mounted on the first integrated circuit board opposite to the low power laser assembly, and the second reflector is movably mounted on the first integrated circuit board, electrically connected with the first controller, and corresponded to the first reflector, for reflecting the laser beam.

11. A wireless charging system comprising:
a power supply device transmitting an electrical energy;
a terminal device for charging;
a laser charging transmitting module comprising a first integrated circuit board electrically connected with the power supply device, a first controller, a light emitting assembly, a low power laser assembly, a first reflector and a second reflector, wherein the first controller is electrically connected with the first integrated circuit board and the low power laser assembly for controlling the low power laser assembly, the low power laser assembly is capable of emitting a laser beam to the laser charging receiving module controlled by the first controller, and the light emitting assembly is electrically connected with the first integrated circuit board, for transforming the electrical energy into a light energy, the first reflector is securely mounted on the first integrated circuit board opposite to the low power laser assembly, and the second reflector is movably mounted on the first integrated circuit board, being electrically connected with the first controller, and corresponds to the first reflector, for reflecting the laser beam; and
a laser charging receiving module comprising a light detector, a second integrated circuit board, a second controller, and a laser detecting assembly, wherein the light detector is electrically connected with the second integrated circuit board, for receiving the light energy transmitted by the laser charging transmitting module, transforming the light energy into the electrical energy, and then transmitting the electrical energy to the second controller and the laser detecting assembly, the second controller is electrically connected with the second integrated circuit board, for controlling the laser detecting assembly, the laser detecting assembly is electrically connected with the second integrated circuit board and the second controller, for receiving the light beam emitted by the low power laser assembly, transforming the light beam into an electrical energy and transmitting the electrical energy to the terminal device for charging to perform charging.

12. The wireless charging system of claim 11, wherein the first controller and the light emitting assembly are placed on the first integrated circuit board.

13. The wireless charging system of claim 11, wherein the laser charging receiving module further comprise a wireless signal transmitter, the wireless signal transmitter is electrically connected with the second integrated circuit board, the light detector, and the second controller, for transmitting a position signal.

14. The wireless charging system of claim 13, wherein the wireless signal transmitter is placed on the second integrated circuit board.

15. The wireless charging system of claim 13, wherein the laser charging transmitting module further comprises a wireless signal receiver, the wireless signal receiver is electrically connected with the first integrated circuit board, for receiving the position signal transmitted by the wireless signal transmitter and transmitting the position signal to the first controller to confirm the position of the laser charging receiving module.

16. The wireless charging system of claim 11, wherein the laser charging receiving module further comprises an electrical connector electrically connected with the second integrated circuit board and the laser detecting assembly, in use, the electrical connector is plugged in the terminal device for charging to be electrically connected therewith, such that the electrical energy transformed by the laser detecting assembly is transmitted to the terminal device for charging via the electrical connector.

17. The wireless charging system of claim 16, wherein the electrical connector is placed on the second integrated circuit board.
